(19) United States
(12) Patent Application Publication
(10) Pub. No.: US 2020/0315092 A1
(43) Pub. Date: Oct. 8, 2020

(54) Expanding coupler for a mower and lawn vacuum

(71) Applicant: Mark Rowell, Mint Hill, NC (US)

(72) Inventor: Mark Rowell, Mint Hill, NC (US)

(21) Appl. No.: 16/372,697

(22) Filed: Apr. 2, 2019

(51) Int. Cl. A01D 43/06; A01D 34/00; A01D 34/71

(52) U.S. Cl. CPC A01D 43/06; A01D 2101/00; A01D 34/71; A01D 34/001

(57) ABSTRACT

The expanding coupler for a mower and lawn vacuum may pull a suction hose adjacent to a deck adapter outlet. A plurality of hose springs may allow the suction hose to separate from the deck adapter outlet when the suction hose is pulled. The shroud may direct clippings from the deck adapter outlet to the suction hose when the suction hose is separated from the deck adapter outlet. As a non-limiting example, the suction hose may couple a deck adapter of a lawn vacuum to a suction hose adapter of the lawn vacuum. The suction hose may be pulled when the riding lawn mower makes a turn in a direction that is opposite the side that the suction hose is on. Fasteners may prevent the suction hose from separating from the hose adapter.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the fields of lawn mowers and lawn vacuums, more specifically, an expanding coupler for a mower and lawn vacuum.

A lawn vacuum may be towed behind a riding lawn mower to collect the clippings produced by the riding lawn mower. The lawn vacuum may comprise a vacuum pump and a collection bin that are mounted on a wheeled frame that is towed behind the lawn mower. A suction hose may direct the lawn clippings from the deck of the riding lawn mower to the intake port of the vacuum pump and the clippings may be blown from the pump into the collection bin. The suction hose may couple to the deck of the riding lawn mower via a deck adapter and may couple to the vacuum pump via a hose adapter. An issue may arise in that the suction hose may decouple from the deck adapter or from the hose adapter when the riding lawn mower makes a sharp turn. The issue may be exacerbated by zero-turn riding lawn mowers which are capable of making sharper turns than other types of riding lawn mowers. Attempts to address the issue by extending the length of the suction hose may be unsuccessful because the excessive length of the suction hose may cause the suction hose to drag on the ground and be run over by the mower rear wheels.

### SUMMARY OF INVENTION

The expanding coupler for a mower and lawn vacuum may pull a suction hose adjacent to a deck adapter outlet. A plurality of hose springs may allow the suction hose to separate from the deck adapter outlet when the suction hose is pulled. The shroud may direct clippings from the deck adapter outlet to the suction hose when the suction hose is separated from the deck adapter outlet. As a non-limiting example, the suction hose may couple a deck adapter of a lawn vacuum to a suction hose adapter of the lawn vacuum. The suction hose may be pulled when the riding lawn mower makes a turn in a direction that is opposite the side that the suction hose is on. Fasteners may prevent the suction hose from separating from the hose adapter.

An object of the invention is to provide an expanding coupler between a suction hose and the deck adapter of a lawn vacuum.

Another object of the invention is to provide a plurality of hose springs to pull the suction hose towards a deck adapter outlet while allowing the suction hose to separate from the deck adapter when the suction hose is being strained.

A further object of the invention is to provide a shroud covering the suction hose and deck adapter outlet to direct clipping from the deck adapter outlet to the suction house when the suction hose is separate from the deck adapter outlet.

Yet another object of the invention is to hold the shroud in place adjacent to the deck adapter by using a shroud retainer.

These together with additional objects, features and advantages of the expanding coupler for a mower and lawn vacuum will be readily apparent to those of ordinary skill in the art upon reading the following detailed description of the presently preferred, but nonetheless illustrative, embodiments when taken in conjunction with the accompanying drawings.

In this respect, before explaining the current embodiments of the expanding coupler for a mower and lawn vacuum in detail, it is to be understood that the expanding coupler for a mower and lawn vacuum is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the expanding coupler for a mower and lawn vacuum.

It is therefore important that the claims be regarded as including such equivalent construction insofar as they do not depart from the spirit and scope of the expanding coupler for a mower and lawn vacuum. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a front view of an embodiment of the disclosure.

FIG. 3 is a rear view of an embodiment of the disclosure.

FIG. 4 is a left side view of an embodiment of the disclosure.

FIG. 5 is a right side view of an embodiment of the disclosure illustrating the front end of the suction hose and desk adapter outlet within the shroud.

FIG. 6 is a top view of an embodiment of the disclosure.

FIG. 7 is an exploded view of an embodiment of the disclosure.

FIG. 8 is an in-use view of an embodiment of the disclosure from the side.

FIG. 9 is a detail view of an embodiment of the disclosure from overhead illustrating the position of the front of the suction hose when the riding lawn mower is not turning.

FIG. 10 is a detail view of an embodiment of the disclosure from overhead illustrating the separation of the suction hose from the deck adapter during a turn.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

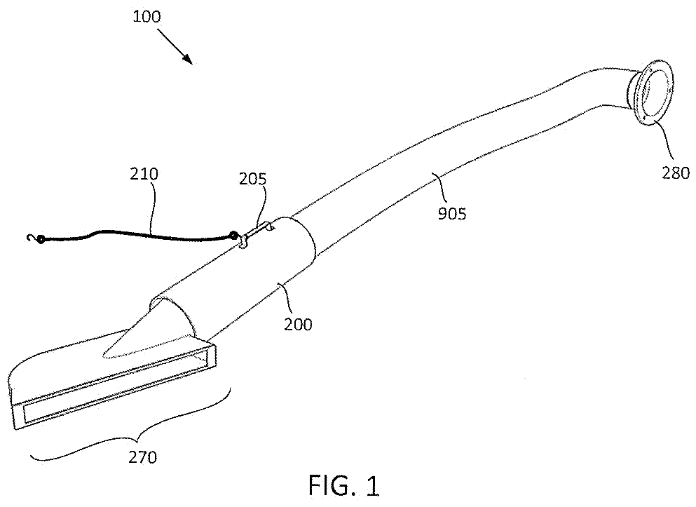

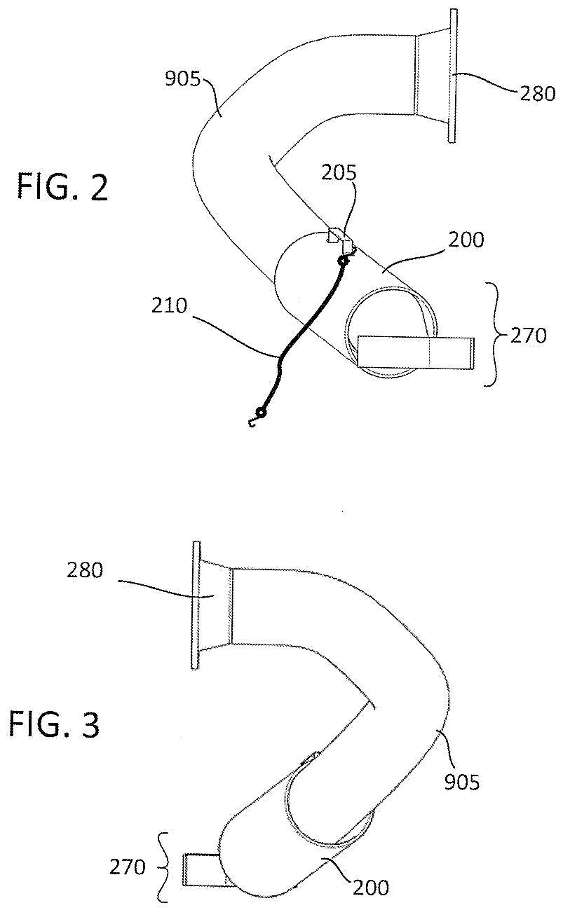

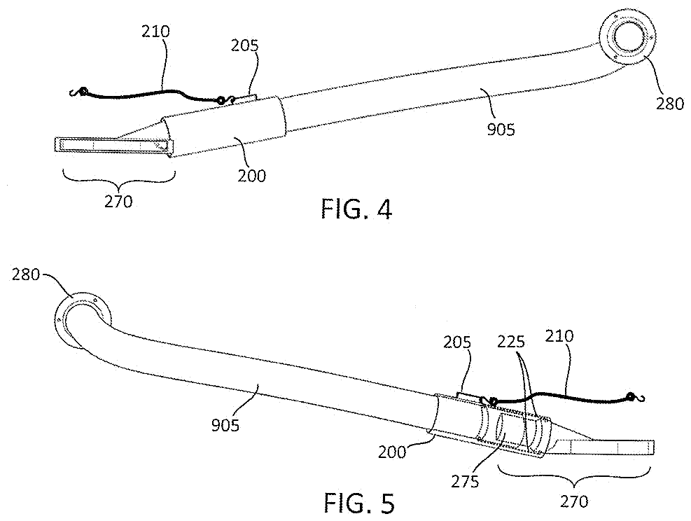

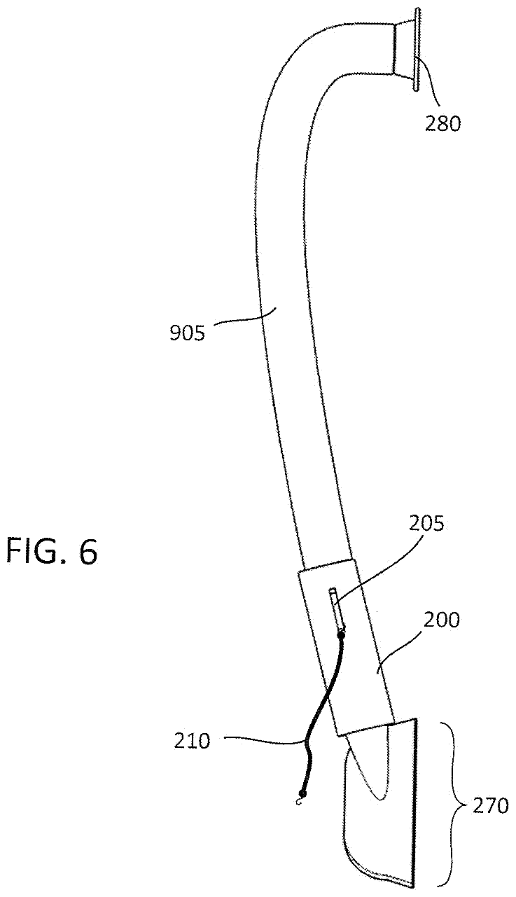

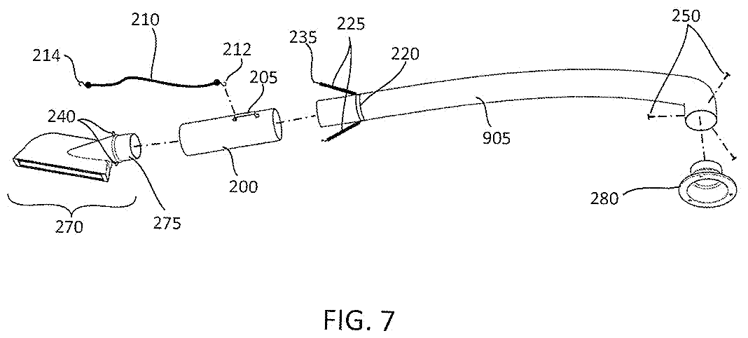

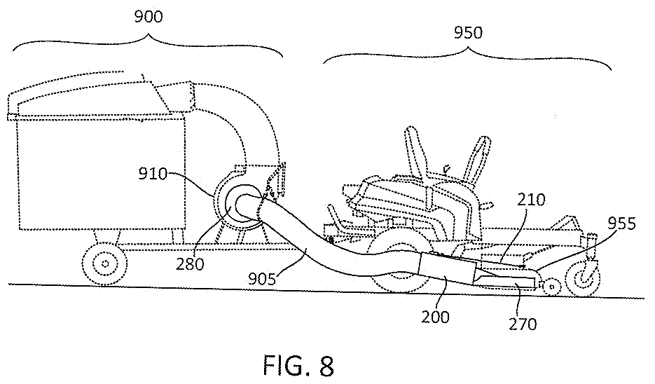

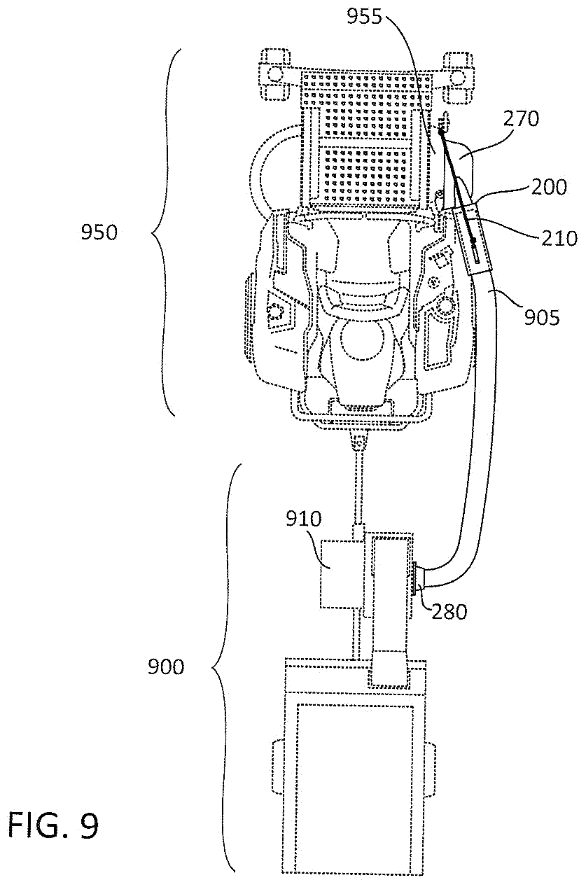

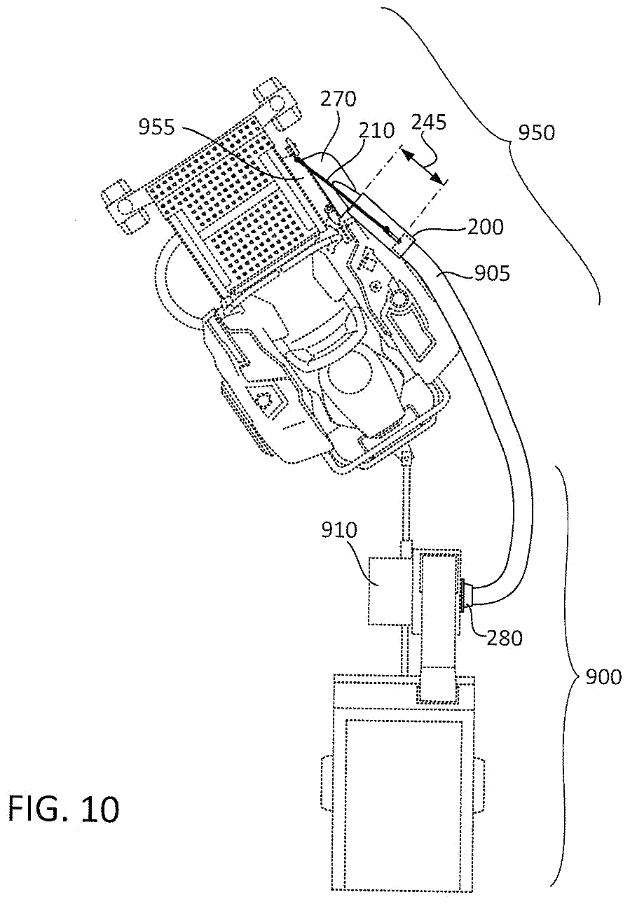

Detailed reference will now be made to a first potential embodiment of the disclosure, which is illustrated in FIGS. 1 through 10.

The expanding coupler for a mower and lawn vacuum 100 (hereinafter invention) comprises a shroud 200, a shroud retainer 210, a hose band 220, a plurality of hose springs 225, and a plurality of latch loops 240. The hose band 220 and the plurality of hose springs 225 may pull a suction hose 905 adjacent to a deck adapter outlet 275. The plurality of hose springs 225 may allow the suction hose 905 to separate from the deck adapter outlet 275 when the suction hose 905 is pulled. The shroud 200 may direct clippings from the deck adapter outlet 275 to the suction hose 905 when the suction hose 905 is separated from the deck adapter outlet 275. As a non-limiting example, the suction hose 905 may couple a deck adapter 270 of a lawn vacuum 900 to a suction hose adapter 280 of the lawn vacuum 900.

The deck adapter 270 may be coupled to a deck 955 of a riding lawn mower 950. The suction hose adapter 280 may be coupled to a vacuum pump 910 of the lawn vacuum 900. The suction hose 905 may be pulled when the riding lawn mower 950 makes a turn in a direction that is opposite the side that the suction hose 905 is on.

The shroud 200 may be a cylindrical tube that covers the coupling between the deck adapter outlet 275 and the suction hose 905. The inside diameter of the shroud 200 may be at least as large as the outside diameter of the suction hose 905 plus twice the diameter of an individual hose spring selected from the plurality of hose springs 225 such that the suction hose 905 and the plurality of hose springs 225 may fit inside the shroud 200. The length of the shroud 200 may be longer than a maximum separation distance 245 between the deck adapter 270 and the suction hose 905. The front end of the shroud 200 may be held adjacent to the deck adapter 270 by the shroud retainer 210. The shroud 200 may comprise a handle 205. The handle 205 may aid in moving the shroud 200 and may: be an attachment point for the shroud retainer 210.

The shroud retainer 210 may be an elastic strap that pulls the shroud 200 forward and holds the front of the shroud 200 adjacent to the deck adapter 270. The rear end of the shroud retainer 210 may couple to the handle 205. In some embodiments, the coupling between the shroud retainer 210 and the handle 205 may be a rear S hook 212 that is detachable from the handle 205.

The front end of the shroud retainer 210 may comprise a front S hook 214. The front S hook 214 may detachably couple to the riding lawn mower 950 at a point in front of the shroud 200. As a non-limiting example, the front S hook 214 may couple to the deck 955 of the riding lawn mower 950.

The hose band 220 may be a rigid or semi-rigid strap that encircles the suction hose 905. The inside diameter of the hose band 220 may match the outside diameter of the suction hose 905 such that the hose band 220 may grasp the outside surface of the suction hose 905 and may resist sliding along the length of the suction hose 905. The ability of the hose band 220 to grasp the suction hose 905 may be enhanced in cases where the suction hose 905 is reinforced with a wire helix. In some embodiments, the hose band 220 may be a hose clamp that may be expanded in diameter to be placed onto the suction hose 905 and may be reduced in diameter to retain its position on the suction hose 905. One end of each of the plurality of hose springs 225 may couple to the hose band 220. The hose band 220 may pull the suction hose 905 towards the deck adapter outlet 275 under the influence of the plurality of hose springs 225. In some embodiments, there may be two of the individual hose springs.

The plurality of hose springs 225 may pull the hose band 220 towards the deck adapter 270. The rear end of each of the individual hose springs may couple to the hose band 220. Each of the plurality of hose springs 225 may be coupled at its front end to a hose spring clip 235. The plurality of hose springs 225 may be equally spaced around the perimeter of the hose band 220. The hose spring clips 235 may removably couple to the plurality of latch loops 240.

The plurality of latch loops 240 may be attachment points for the hose spring clips 235. The plurality of latch loops 240 may be distributed around the perimeter of the deck adapter outlet 275. There may be one of the plurality of latch loops 240 for each of the individual hose springs. The spacing of the plurality of latch loops 240 around the deck adapter outlet 275 may match the spacing of the plurality of hose springs 225 around the hose band 220.

In some embodiments, the invention 100 may comprise a plurality of hose fasteners 250. The plurality of hose fasteners 250 may couple the rear end of the suction hose 905 to the suction hose adapter 280 to prevent the rear end of the suction hose 905 from pulling off of the suction hose adapter 280 when the front end of the suction hose 905 is unable to pull off of the deck adapter 270. As non-limiting examples, the plurality of hose fasteners 250 may be screws or rivets.

To install the invention 100, the plurality of latch loops are installed on the deck adapter outlet 275 if not pre-installed. As non-limiting examples, installation of the plurality of latch loops 240 may involve drilling one or more holes into the deck adapter outlet 275, screwing one or more screws, riveting, applying an adhesive, or combinations thereof. The plurality of hose fasteners 250 may be installed at the overlap of the suction hose 905 and the suction hose adapter 280 if not pre-installed. As non-limiting examples, installation of the plurality of hose fasteners 250 may involve drilling one or more holes, screwing one or more screws, riveting, or combinations thereof. Installation continues by coupling the hose band 220 to the suction hose 905. The distance from the front end of the suction hose 905 to the hose band 220 is correct when the front of the suction hose 905 is adjacent to the deck adapter 270 and the individual hose springs extend from the plurality of latch loops 240 to the hose band 220 without stretching the individual hose springs. With the suction hose 905 separated from the deck adapter 270, the shroud 200 may be slid onto the front end of the suction hose 905 and positioned to the rear of the hose band 220. The hose spring clips 235 at the front end of the individual hose springs may be coupled to the plurality of latch loops 240 on the deck adapter outlet 275.

The shroud 200 may slide forward until it is adjacent to the deck adapter 270. Installation may be completed by coupling the rear end of the shroud retainer 210 to the handle 205 and the front end of the shroud retainer 210 to the deck 955 to keep the shroud 200 pulled forward.

With the invention 100 installed, the riding lawn mower 950 is driven forward pulling the lawn vacuum 900 behind it. The front end of the suction hose 905 may remain in contact with the deck adapter outlet 275 unless the riding lawn mower 950 makes a sharp turn. As a non-limiting example, with the suction hose 905 located on the right side of the riding lawn mower 950 and the lawn vacuum 900, a sharp turn to the left may pull the suction hose 905 to its maximum length, at which point the suction hose 1905 could pull off of the deck adapter 270 in the absence of the invention 100. With the invention 100 installed, the front end of the suction hose 905 may separate from the deck adapter outlet 275 while remaining inside of the shroud 200. The shroud may direct the clippings from the deck adapter outlet 275 to the front end of the suction hose 905 while the suction hose 905 and the deck adapter outlet 275 are separated. When the riding lawn mower 950 and the lawn vacuum 900 are aligned again, the plurality of hose springs 225 may pull the front end of the suction hose 905 back to a position adjacent to the deck adapter outlet 275.

### Definitions

As used herein, an “adapter” refers to a device that is designed to convert a first interface to a second interface. The conversion may require changes in mechanical shape or size, electrical signaling, power levels, pressures, or other physical attributes.

As used in this disclosure, a “band” is a flat loop of material.

As used herein, the words “couple”, “couples”, “coupled” or “coupling”, refer to connecting, either directly or indirectly, and does not necessarily imply a mechanical connection.

As used in this disclosure, “elastic” refers to a material or object that deforms when a force is applied to it and that is able to return to its relaxed shape after the force is removed. A material that exhibits these qualities is also referred to as an elastomeric material.

As used herein, “front” indicates the side of an object that is closest to a forward direction of travel under normal use of the object or the side or part of an object that normally presents itself to view or that is normally used first. “Rear” or “back” refers to the side that is opposite the front.

As used in this disclosure, a “handle” is an object by which a tool, object, or door is held or manipulated with the hand.

As used in this disclosure, a “helix” is the three dimensional structure that is formed by a wire that is wound uniformly around the surface of a cylinder or a cone. If the wire is wrapped around a cylinder the helix is called a cylindrical helix. If the wire is wrapped around a cone, the helix is called a conical helix. A synonym for conical helix would be a volute. “Helical” is an adjective which indicates that an object is shaped like a helix.

As used herein, “inside diameter” or “inner diameter” refers to a measurement made on a hollow object. Specifically, the inside diameter is the distance from one inside wall to the opposite inside wall. If the object is round, then the inside diameter is a true diameter, however the term may also be used in connection with a square object in which case the inside diameter is simply the narrowest inside measurement that passes through the center of the object.

As used herein, “outside diameter” or “outer diameter” refers to a measurement made on an object. Specifically, the outside diameter is the distance from one point on the outside of the object to a point on the opposite side of the object along a line passing through the center of the object. The term outside diameter is frequently used in conjunction with round objects such as hollow conduits in which case the outside diameter is a true diameter, however the term may also be used in connection with a square object in which case the outside diameter is simply the widest outside measurement that passes through the center of the conduit.

As used in this disclosure, a “perimeter” is one or more curved or straight lines that bound an enclosed area on a plane or surface. The perimeter of a circle is commonly referred to as a circumference.

As used in this disclosure, a “pump” is a mechanical or electromechanical device that uses suction or pressure to raise or move fluids, compress fluids, or force a fluid into an inflatable object. As non-limiting examples, fluids may include both liquids, such as water, and gases, such as air.

As used in this disclosure, “resilient” or “semi-rigid” refer to an object or material which will deform when a force is applied to it and which will return to its original shape when the deforming force is removed.

As used herein, “rigid” refers to an object or material which is inflexible. If a force is applied to a rigid object the rigid object does not bend or deform unless the force applied reaches the breaking point of the rigid object.

As used in this disclosure, a “spring” is a device that is used to store mechanical energy. This mechanical energy will often be stored by deforming an elastomeric material that is used to make the device, by the application of a torque to a rigid structure, or by a combination thereof. In some embodiments, the rigid structure to which torque is applied may be composed of metal or plastic.

As used in this disclosure a “strap” is a strip of leather, cloth, nylon, plastic, thin metal, rubber, or other flexible material, that is used to fasten, secure, carry, or hold onto something. A strap is sometimes used in conjunction with a buckle.

As used in this disclosure, a “tube” is a hollow cylindrical device that is used for transporting liquids and/or gases. In this disclosure, the terms inner diameter and outer diameter are used as they would be used by those skilled in the plumbing arts. The line that connects the center of the first base of the cylinder to the center of the second base of the cylinder and is equidistant from the outer surface of the tube for its entire length is referred to as the centerline of the tube. When two tubes share the same centerline they are said to be aligned. When the centerlines of two tubes are perpendicular to each other, the tubes are said to be perpendicular to each other. As used here, “tubing” refers to a tube that is flexible or resilient.

With respect to the above description, it is to be realized that the optimum dimensional relationship for the various components of the invention described above and in FIGS. 1 through 10, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which twill fall within the spirit and scope of the present invention as defined in the following claims. Accordingly, the invention is to be limited only by the scope of the following claims and their equivalents.

What is claimed is:

1. A expanding coupler for a mower and lawn vacuum comprising:
a shroud, a shroud retainer, a hose band, a plurality of hose springs, and a plurality of latch loops;
wherein the hose band and the plurality of hose springs pull a suction hose adjacent to a deck adapter outlet;
wherein the plurality of hose springs allow the suction hose to separate from the deck adapter outlet when the suction hose is pulled;
wherein the shroud directs clippings from the deck adapter outlet to the suction hose when the suction hose is separated from the deck adapter outlet.

2. The expanding coupler for a mower and lawn vacuum according to claim 1
wherein the shroud is a cylindrical tube that covers the coupling between the deck adapter outlet and the suction hose.

3. The expanding coupler for a mower and lawn vacuum according to claim 2
wherein the inside diameter of the shroud is at least as large as the outside diameter of the suction hose plus twice the diameter of an individual hose spring selected from the plurality of hose springs such that the suction hose and the plurality of hose springs fit inside the shroud.

4. The expanding coupler for a mower and lawn vacuum according to claim 3
wherein the length of the shroud is longer than a maximum separation distance between a deck adapter and the suction hose.

5. The expanding coupler for a mower and lawn vacuum according to claim 4
wherein the front end of the shroud is held adjacent to the deck adapter by the shroud retainer.

6. The expanding coupler for a mower and lawn vacuum according to claim 5
wherein the shroud comprises a handle;
wherein the handle aids in moving the shroud;
wherein the handle is an attachment point for the shroud retainer.

7. The expanding coupler for a mower and lawn vacuum according to claim 6
wherein the shroud retainer is an elastic strap that pulls the shroud forward and holds the front of the shroud adjacent to the deck adapter;
wherein the rear end of the shroud retainer couples to the handle.

8. The expanding coupler for a mower and lawn vacuum according to claim 7
wherein the coupling between the shroud retainer and the handle is a rear S hook that is detachable from the handle;
wherein the front end of the shroud retainer comprises a front S hook;
wherein the front S hook detachably couples to a riding lawn mower at a point in front of the shroud.

9. The expanding coupler for a mower and lawn vacuum according to claim 8
wherein the front S hook couples to a deck of the riding lawn mower.

10. The expanding coupler for a mower and lawn vacuum according to claim 7
wherein the hose band is a rigid or semi-rigid strap that encircles the suction hose;
wherein the inside diameter of the hose band matches the outside diameter of the suction hose such that the hose band grasps the outside surface of the suction hose and resists sliding along the length of the suction hose.

11. The expanding coupler for a mower and lawn vacuum according to claim 10
wherein the hose band is a hose clamp that is expanded in diameter to be placed onto the suction hose and is reduced in diameter to retain its position on the suction hose.

12. The expanding coupler for a mower and lawn vacuum according to claim 10
wherein one end of each of the plurality of hose springs couples to the hose band;
wherein the hose band pulls the suction hose towards the deck adapter outlet under the influence of the plurality of hose springs.

13. The expanding coupler for a mower and lawn vacuum according to claim 12
wherein there are two of the individual hose springs.

14. The expanding coupler for a mower and lawn vacuum according to claim 12
wherein the plurality of hose springs pull the hose band towards the deck adapter.

15. The expanding coupler for a mower and lawn vacuum according to claim 14
wherein the rear end of each of the individual hose springs couples to the hose band;
wherein each of the plurality of hose springs are coupled at the front end of the individual hose spring to a hose spring clip.

16. The expanding coupler for a mower and lawn vacuum according to claim 15
wherein the plurality of hose springs are equally spaced around the perimeter of the hose band.

17. The expanding coupler for a mower and lawn vacuum according to claim 15
wherein the hose spring clips removably couple to the plurality of latch loops.

18. The expanding coupler for a mower and lawn vacuum according to claim 17
wherein the plurality of latch loops are attachment points for the hose spring clips;
wherein the plurality of latch loops are distributed around the perimeter of the deck adapter outlet;
wherein there is one of the plurality of latch loops for each of the individual hose springs;
wherein the spacing of the plurality of latch loops around the deck adapter outlet match the spacing of the plurality of hose springs around the hose band.

19. The expanding coupler for a mower and lawn vacuum according to claim 18
wherein the expanding coupler for a mower and lawn vacuum comprises a plurality of hose fasteners;
wherein the plurality of hose fasteners couple the rear end of the suction hose to a suction hose adapter to prevent the rear end of the suction hose from pulling off of the suction hose adapter when the front end of the suction hose is unable to pull off of the deck adapter.
